(19) United States
(12) Patent Application Publication
(10) Pub. No.: US 2012/0125948 A1
(43) Pub. Date: May 24, 2012

(54) CARDBOARD TUBE CONTAINER OF WHICH THE CONTENTS CAN BE REFILLED

(75) Inventors: Su-Jin SON, Incheon (KR); Joong-Gu KIM, Seoul (KR)

(73) Assignee: YONWOO CO., LTD., Incheon (KR)

(21) Appl. No.: 13/363,316

(22) Filed: Jan. 31, 2012

Related U.S. Application Data
(63) Continuation of application No. PCT/KR2009/006221, filed on Oct. 27, 2009.

(30) Foreign Application Priority Data
Jul. 31, 2009 (KR) 10-2009-0070645

(51) Int. Cl. B65D 35/56; B67D 7/60; B65D 88/54

(52) U.S. Cl. 222/105; 222/386.5; 222/321.7

(57) ABSTRACT

Disclosed is a cardboard tube container of which the contents can be refilled, which comprises a cardboard tube body which has a space for accommodating a content; a fixture part which is engaged to an inner, upper side of the cardboard tube body and has a protrusion formed along an upper, outer circumferential surface; a pouch which is secured to a lower side of the fixture part and accommodates a content and is detachable from the fixture part for an exchange of itself when a content is all consumed; a pumping member which is secured to an upper side of the fixture part and serves to discharge the content stored in the pouch to the outside by way of a pumping operation and is detachable from the cardboard tube body; and a cardboard tube cap which is secured to an upper side of the cardboard tube body.

### TECHNICAL FIELD

The present invention relates to a cardboard tube container of which the contents can be refilled, and in particular to a cardboard tube container of which the contents can be refilled, characterized in that a body is made from a cardboard tube, and a pumping member is detachable from a cardboard tube body. When all content is consumed, the pumping member is separated from the cardboard tube body, and a pouch engaged to the lower side of the same is exchanged, thus easily refilling content.

### BACKGROUND ART

Shampoo, rinse, cosmetics, etc. are sold in a container. They are generally available in a disposable pouch type at a low price.

A user refills pouch content into a shampoo, rinse or cosmetic container so as to save cost. In this case, a pouch is cut, and the content of the same is refilled into the container, which causes a lot of inconveniences.

In order to overcome the above problems, a refill type cosmetic container of Korean utility model number 20-0282756 is disclosed.

The above utility model is characterized in that in a conventional cosmetic container formed of a container body storing content, and a closure thread-engaged with the container body, there are provided an outer container 10 in which at an upper side is formed a hole 11 for receiving an opening 22 of an inner container 20 in a tube shape, and a thread 12 is formed at an outer surface of a lower side protruded from an outer side to an inner side so as to thread-engage a finishing cap 30, and a groove 13 receives a protrusion 23 formed at both sides of an outer surface of a lower side of an inner container 20 below the threaded portion, an inner container 20 which has a content accommodation part body 21 having a diameter corresponding to an inner diameter of the outer container 10 and a length corresponding to the inner length, and a protrusion 23 is formed to both sides and is inserted into the groove 13 formed at a lower side of the outer container 10 of a lower side of an outer surface of the content accommodation part body 21, and has an opening 23 inserted into the hole 11 of the outer container 10 at the upper side, with the opening 23 being thread-engaged with a cap 40; and a finishing cap 30 which is thread-engaged to the thread 12 formed at a lower side of the outer container 10 with the inner container 20, thus fixing the inner container 20 in the outer container 10.

The above utility model is characterized in that the inner container 2 with certain content can be exchanged. The groove 13 and the protrusion 23 are formed at each container for a fixture of the outer container 10 and the inner container 20, and the finishing cap 30 is engaged to the thread 12 formed at a lower side of the outer container 10, the construction of which looks very complicated, thus increasing manufacture cost and requiring long time to manufacture the products.

The above utility model is directed to a structure that air is inputted into the content while the cap 40 is separated from the inner container 20, so it can be applied to a container for lotion, skin, etc., it cannot be applied to a functional cosmetic which does not need air input so as to prevent the spoilage of the content.

### DISCLOSURE OF INVENTION

Accordingly, the present invention overcomes the above-described problems and it is an object of the present invention to provide a cardboard tube container of which the contents can be refilled, characterized in that a body is made from a cardboard tube, and a pumping member is detachable from a cardboard tube body. When all content is consumed, the pumping member is separated from the cardboard tube body, and a pouch engaged to the lower side of the same is exchanged, thus easily refilling content.

It is another object of the present invention to provide a cardboard tube container of which the contents can be refilled, characterized in that an engaging part with a thread at an upper side of a pouch is provided, so an easier exchange of a pouch can be possible by exchanging or disengaging a thread, and a pumping member is engaged at an upper side of a pouch, thus preventing the input of air even when a cardboard tube cap is separated.

To achieve the above object, there is provided a cardboard tube container of which the contents can be refilled, comprising a cardboard tube body which has a space for accommodating a content; a fixture part which is engaged to an inner, upper side of the cardboard tube body and has a protrusion formed along an upper, outer circumferential surface; a pouch which is secured to a lower side of the fixture part and accommodates a content and is detachable from the fixture part for an exchange of itself when a content is all consumed; a pumping member which is secured to an upper side of the fixture part and serves to discharge the content stored in the pouch to the outside by way of a pumping operation and is detachable from the cardboard tube body; and a cardboard tube cap which is secured to an upper side of the cardboard tube body.

In addition, at an lower, outer circumferential surface of the fixture part is formed a thread, and an engaging part with a thread is formed at an upper, inner side of the pouch, so they are detachable from each other by way of a thread engagement.

In addition, a cardboard tube shorter than the cardboard tube body is secured to an inner side of the cardboard tube body, thus forming an engaging shoulder.

In addition, a slope surface is formed in an inward direction at a lower side of the protrusion, so the fixture part is tightly inserted into the cardboard tube body, and then is mounted at the engaging shoulder and is finally fixed to the cardboard tube body.

### ADVANTAGEOUS EFFECTS

The present invention is advantageous that a body is made from a cardboard tube, and a pumping member is detachable from a cardboard tube body. When all content is consumed, the pumping member is separated from the cardboard tube body, and a pouch engaged to the lower side of the same is exchanged, thus easily refilling content.

An engaging part with a thread at an upper side of a pouch is provided, so an easier exchange of a pouch can be possible by exchanging or disengaging a thread, and a pumping member is engaged at an upper side of a pouch, thus preventing the input of air even when a cardboard tube cap is separated.

### BRIEF DESCRIPTION OF THE DRAWINGS

The present invention will become better understood with reference to the accompanying drawings which are given only by way of illustration and thus are not limitative of the present invention, wherein;

FIG. 1 is a disassembled perspective view illustrating a construction of a cardboard tube container of which the contents can be refilled according to a preferred embodiment of the present invention;

FIG. 2 is a cross sectional view illustrating a construction of a cardboard tube container of which the contents can be refilled according to a preferred embodiment of the present invention;

FIG. 3 is a disassembled cross sectional view illustrating a construction of a cardboard tube container of which the contents can be refilled according to a preferred embodiment of the present invention; and

FIG. 4 is a view illustrating a state of use of a cardboard tube container of which the contents can be refilled according to a preferred embodiment of the present invention.

### BEST MODES FOR CARRYING OUT THE INVENTION

The preferred embodiments of the present invention will be described with reference to the accompanying drawings. The same elements of the drawings are given the same reference numerals.

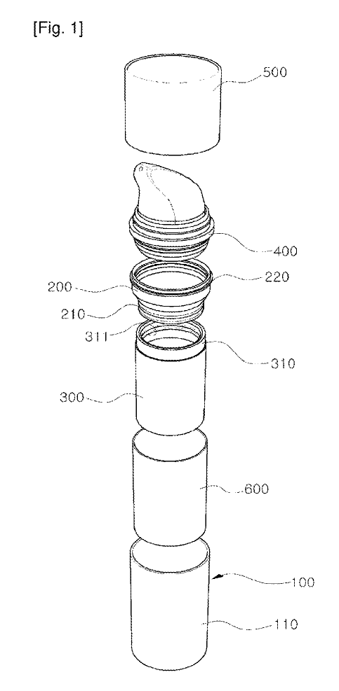

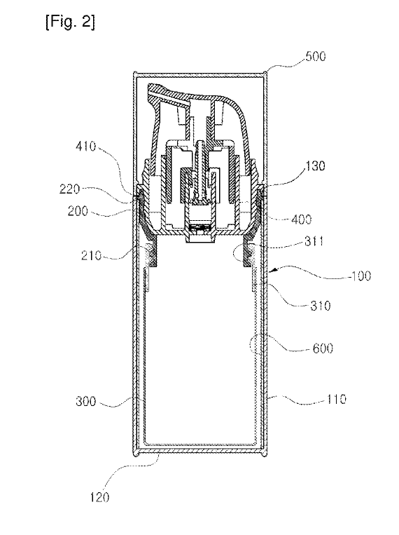

FIG. 1 is a disassembled perspective view illustrating a construction of a cardboard tube container of which the contents can be refilled according to a preferred embodiment of the present invention, and FIG. 2 is a cross sectional view illustrating a construction of a cardboard tube container of which the contents can be refilled according to a preferred embodiment of the present invention.

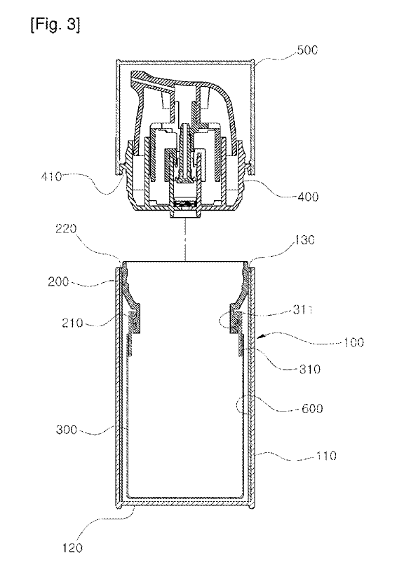

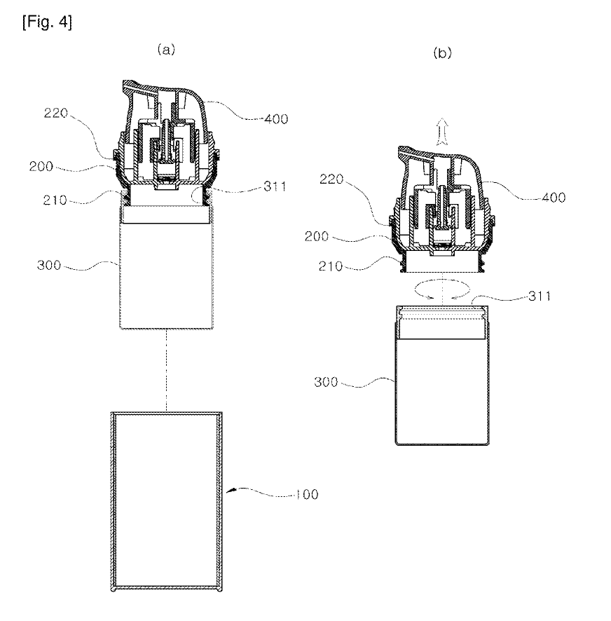

FIG. 3 is a disassembled cross sectional view illustrating a construction of a cardboard tube container of which the contents can be refilled according to a preferred embodiment of the present invention, and FIG. 4 is a view illustrating a state of use of a cardboard tube container of which the contents can be refilled according to a preferred embodiment of the present invention.

As shown in FIGS. 1 through 4, the cardboard tube container with a content refill function according to a preferred embodiment of the present invention comprises a cardboard tube body 100, a fixture part 200, a pouch 300, a pumping member 400, and a cardboard tube cap 500.

The cardboard tube body 100 has a space storing content and a cardboard tube part 110 forming its side surface, and a support part 120 formed at a lower side of the cardboard tube part 110, thus closing the lower side.

In the present invention, the cardboard tube body 100 is made from paper, and when a cosmetic container is made in such a way to forcibly insert the fixture part 200 by means of a pressure from a user, the work for manufacturing an engaging part for an engagement with each element can be omitted, thus saving manufacture time and cost.

The cardboard tube body 100 is made from paper, so a post process can be easily performed since a certain letter, graphic, symbol, etc. can be formed at an outer surface or various colors might be provided thereon, thus reducing defects.

The cardboard tube body 100 is made from paper, so recycling is possible at a time of its disposal, thus reducing contamination.

The present invention is characterized in that the cardboard tube 600 shorter than the cardboard tube body 100 is engaged to an inner side of the cardboard tube body 100. The cardboard tube 600 is engaged in a longitudinal direction, surrounding an inner surface of the cardboard tube body 100 and is shorter than the cardboard tube body 100, thus forming an engaging shoulder 130. The cardboard tube 100 is engaged to an inner surface of the cardboard tube body 100, thus forming the engaging shoulder 130, which helps mount the protrusion 220 formed at the fixture part 200, thus limiting a movement range of the fixture part 200, whereby the fixture part 200 is fixed to the cardboard tube body 100.

The fixture part 200 is engaged to an inner upper side of the cardboard tube body 100 and has a hollow part for filling and discharging content.

The fixture part 200 has a protrusion 220 formed along an outer surface at a portion coming into contact with the engaging shoulder 130, and a slope surface is formed in an inward direction at the lower side of the protrusion 220, so it is tightly inserted from a lower side to an upper side of the cardboard tube body 100 and then is mounted at the upper side of the engaging shoulder 130, thus being fixed at the cardboard tube boy 100. The fixture part 200 preferably is larger than the diameter of the cardboard tube body 100 for a tight insertion and then fixture into the cardboard tube body 100.

A thread 210 is formed at an outer surface of the lower side of the fixture part 200, and the pouch 300 is engaged to the lower side of the fixture part 200. As the thread 210 is provided, the exchange of the pouch 300 can be easily performed by way of the engagement and disengagement with the engaging part 310 engaged to the upper side of the pouch 300.

The pouch 30 is engaged to the lower side of the fixture part 200 in the cardboard tube body 100 and stores content. In the present invention, the pouch 300 is detachably engaged to the fixture part 200 for exchange when the content is all consumed.

The pouch 300 includes an engagement part 310 at its upper side for an engagement with the fixture part 200, and along an inner circumferential surface of the inner side of the engagement part 310 is formed a thread 311 for a thread engagement with the thread 210 formed at an outer surface of the fixture part 200. So, the pouch 300 can be detached by way of a thread engagement between the fixture part 200 and the engagement part 310.

The pumping member 400 is engaged to the upper side of the fixture part 200 and is directed to discharging the content in the pouch 300 to the outside by means of a pumping operation. It is preferred that an engaging groove 410 is formed at a portion contacting with the upper side of the fixture part 200.

In the present invention, the pumping member 400 is detachable from the cardboard tube body 100. The pumping member of a conventional cosmetic container is generally stably secured by means of a fixing member like a support cap; however in the present invention the pumping member 400 is easily disengaged from the cardboard tube body 100 by means of a user's pressure for an exchange of the pouch 300 if necessary.

The pumping member 400 is engaged to the fixture part 200, so the fixture part 200 is disengaged together when a user disengage the pumping member 400 from the cardboard tube body 100. At this time, the pouch 300 secured to a lower side of the fixture part 200 is disengaged, thus exchanging the pouch 300.

When the exchange of the pouch 300 is completed, the user secures the pumping member 400 to the cardboard tube body 100 while holding the pumping member. At this time, the fixture part 200 is slowly engaged to the cardboard tube body 100, and then is mounted at the engaging shoulder 130 formed by means of the cardboard tube body 100 and the cardboard tube 600, thus being fixed with the cardboard tube body 100.

The construction for a pumping operation of the pumping member 400 is known in the art, so the descriptions thereof will be omitted.

The cardboard tube cap 500 is secured to the upper side of the cardboard tube body 100, surrounding the pumping member 400, thus protecting the pumping member 400 from an external impact, which leads to a prevention of malfunctions.

The pouch exchange procedure of the cardboard tube container with a content refill function according to a preferred embodiment of the present invention will be described with reference to FIGS. 1 through 4.

As shown in FIGS. 1 through 4, when content is all consumed, a user lifts up the pumping member 400 with hands, thus disengaging the pumping member 400 from the cardboard tube body 100. At this time, the fixture part 200 secured to the engaging groove 410 of the pumping member 400 is disengaged together, and the pouch 300 secured to the thread 210 of the fixture part 200 is disengaged together.

When the fixture part 200 and the pouch 300 are disengaged from the cardboard tube body 100 as the pumping member 400 is lifted up, the user rotates the engaging part 310 secured to the upper side of the pouch 300 in one direction, thus disengaging the pouch 300 from the fixture part 200, and a new pouch with content is engaged to the fixture part 200, thus finishing an exchange of the pouch 300.

When the exchange of the pouch 300 is finished, the pumping member 400 is secured to the cardboard tube body 100. When the pumping member 400 is pressurized from the upper side to the lower side of the cardboard tube body 100, the fixture 200 is slowly engaged to the cardboard tube body 100, and is mounted at the engaging shoulder 130 formed by the cardboard tube body 100 and the cardboard tube 600, so it is tightly engaged to the cardboard tube body 100. Here, it is preferred that the fixture part 200 is a little larger than the diameter of the cardboard tube body 100 for a tight engagement into the cardboard tube body 100. In addition, since the cardboard tube body 100 has preferably a certain thickness to the extent to prevent any deformation during a tight engagement with the fixture part 200 because it is made from paper.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

1. A cardboard tube container of which the contents can be refilled, comprising:
a cardboard tube body which has a space for accommodating a content;
a fixture part which is engaged to an inner, upper side of the cardboard tube body and has a protrusion formed along an upper, outer circumferential surface;
a pouch which is secured to a lower side of the fixture part and accommodates a content and is detachable from the fixture part for an exchange of itself when a content is all consumed;
a pumping member which is secured to an upper side of the fixture part and serves to discharge the content stored in the pouch to the outside by way of a pumping operation and is detachable from the cardboard tube body; and
a cardboard tube cap which is secured to an upper side of the cardboard tube body.

2. The container of claim 1, wherein at an lower, outer circumferential surface of the fixture part is formed a thread, and an engaging part with a thread is formed at an upper, inner side of the pouch, so they are detachable from each other by way of a thread engagement.

3. The container of claim 1, wherein a cardboard tube shorter than the cardboard tube body is secured to an inner side of the cardboard tube body, thus forming an engaging shoulder.

4. The container of claim 3, wherein a slope surface is formed in an inward direction at a lower side of the protrusion, so the fixture part is tightly inserted into the cardboard tube body, and then is mounted at the engaging shoulder and is finally fixed to the cardboard tube body.
